(19) United States
(12) Patent Application Publication
(10) Pub. No.: US 2023/0182754 A1
(43) Pub. Date: Jun. 15, 2023

(54) DETERMINING AN ANOMALOUS EVENT FROM A SCENARIO AND AN ACTION OF INTEREST

(71) Applicant: GM Cruise Holdings LLC, San Francisco, CA (US)

(72) Inventors: Zisu Dong, Emeryville, CA (US); Da Fang, San Francisco, CA (US)

(21) Appl. No.: 17/549,510

(22) Filed: Dec. 13, 2021

(51) Int. Cl. B60W 50/06; G06N 20/00; B60W 60/00; B60W 30/18; B60W 40/02

(52) U.S. Cl. CPC B60W 50/06; B60W 30/18009; B60W 40/02; B60W 60/001; G06N 20/00

(57) ABSTRACT

A method is provided for determining a probability of an anomalous event based on a scenario and an action of interest. The method may include receiving data defining the scenario by an anomalous event prediction algorithm for determining a probability of an action of interest. The method may also include outputting a probability of an anomalous event occurring for the action of interest taken in response to the scenario. The method may also include providing the probability of the anomalous event to an algorithm evaluating the action of interest. The algorithm evaluating the action of interest uses the probability of the anomalous event to avoid the action of interest leading to the anomalous event or recognize the anomalous event more quickly to take steps to ameliorate a consequence of the anomalous event.

### TECHNICAL FIELD

The subject technology pertains to determining an anomalous event from a current scenario and an intended autonomous vehicle (AV) action.

### BACKGROUND

An autonomous vehicle is a motorized vehicle that can navigate without a human driver. An exemplary autonomous vehicle includes a plurality of sensor systems, including a camera sensor system, a LIDAR sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system. In some applications, these systems utilize a perception system (or perception stack) that implements various computing vision techniques to reason about the surrounding environment.

### SUMMARY

The present technology is directed to determining a probability of an anomalous event based on a scenario and an action of interest. The present technology may include receiving data defining the scenario by an anomalous event prediction algorithm for determining a probability of action of interest. The present technology m ay also include outputting a probability of an anomalous event occurring for the action of interest taken in response to the scenario. The present technology may also include providing the probability of the anomalous event to an algorithm evaluating the action of interest. The algorithm evaluating the action of interest uses the probability of the anomalous event to avoid the action of interest leading to the anomalous event or recognize the anomalous event more quickly to take steps to ameliorate a consequence of the anomalous event.

Additional aspects, embodiments, and features are set forth in part in the description that follows and will become apparent to those skilled in the art upon examination of the specification or may be learned by the practice of the disclosed subject matter. A further understanding of the nature and advantages of the disclosure may be realized by reference to the remaining portions of the specification and the drawings, which form a part of this disclosure.

### BRIEF DESCRIPTION OF THE FIGURES

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a system for managing one or more Autonomous Vehicles (AVs) in accordance with some aspects of the present technology;

FIG. 2 is a diagram illustrating an anomalous event prediction algorithm for determining the probability of an anomalous event in accordance with some aspects of the present technology;

FIG. 3 is a diagram illustrating the anomalous event prediction algorithm of FIG. 2, and an algorithm evaluating actions of interest communicating with a planning stack of an autonomous vehicle (AV) in accordance with some aspects of the present technology;

FIG. 4 illustrates an example method for determining a probability of an anomalous event based on a scenario and an action of interest in accordance with some aspects of the present technology;

FIG. 5 illustrates an example method for training a machine learning algorithm for anomalous event prediction in accordance with some aspects of the present technology;

FIG. 6 shows two potential actions of interest in accordance with some aspects of the present technology; and

FIG. 7 is an example of a computing system in accordance with some aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form to facilitate describing one or more aspects. Further, it is to be understood that functionality described as being carried out by certain system components may be performed by more or fewer components than shown.

As described herein, one aspect of the present technology is the gathering and using data available from various sources to improve quality and experience. The present disclosure contemplates that in some instances, this gathered data may include personal information. The present disclosure contemplates that the entities involved with such personal information respect and value privacy policies and practices.

The disclosure addresses the need to develop methods to recognize an undesirable situation early before it is too late to react for an autonomous vehicle (AV), which can help with taking an action to respond to the undesirable situation. The disclosure provides methods for detection and semantic understanding of an anomalous event. Anomalous events can occur in the context of AVs when input data has not been seen often enough by the machine learning algorithms that the AV uses to pilot itself (i.e., out-of-distribution situations) or error introduced in perception, prediction, or planning pipelines. While anomalous events might result from some actions taken by the AV, the present technology recognizes that it might be possible to predict that some actions are more likely to lead to an anomalous event. The present technology can also be beneficial in quickly recognizing that an action already taken has led to an anomalous result.

The disclosure provides an Anomalous event prediction algorithm, which evaluates action candidates when it is provided online access to current state information of the AV and when given a potential or executed AV action. The anomalous event prediction algorithm is AV-centric because the primary concerns are road events that result from actions taken by the AV. The anomalous event prediction algorithm is also action-based and can be referred to as an action-conditioned model because the anomalous event predictions are based on an action planned or taken by the AV. The road events may include situations like an AV collision, the AV getting stuck somewhere, the AV blocking a region that it should not, among others.

The AV-centric model evaluates actions and predicts a probability of an event that is both interpretable and relevant to downstream consumers. The output of the anomalous event prediction algorithm can help a machine learning model (e.g., a planning stack) to react to the probability of the event with low latency.

The anomalous event prediction algorithm is also independent of the planning stack of the AV. The action-conditioned model implies learning everything above the “scenario or observation” layer and below the “action” layer. Therefore, the action-conditioned model uses raw signals whenever possible and uses processed signals only when necessary and feasible, including the semantic map, Lidar occupancy map, perception summary (e.g., object bounding boxes, labels, path, pose), prediction summary for each object at next time interval (e.g., predicted paths, probabilities, and distribution of deviation from predicted paths).

The action-conditioned model predicts p(e|s, a), where p denotes a probability, e denotes target events, s denotes current scenario observation, and a denotes the action of interest, where the action of interest is defined as the trajectory represented as waypoints within a fixed time interval.

In a dynamic problem space like autonomous driving, all road events are action-conditioned. In other words, events are dependent on actions taken by a vehicle, such as the AV. For example, an AV may drastically turn right at any location, crash into the sidewalk at the location, and induce a safety event, but this action does not make every scenario equally safe or unsafe since norms of the road, which are encoded as policies in the AV, dictate that crashing into sidewalks is not normal. A direct prediction of a probability of an event occurring given an input scenario (p(e|s)) predicts p(els,π(a)), where π denotes the policy when the road event takes place (i.e., the model implicitly picks up a fixed model of action policy), where p(e|s, a) is a probability of an event given an input scenario, and an action to evaluate (a planned action or an action taken).

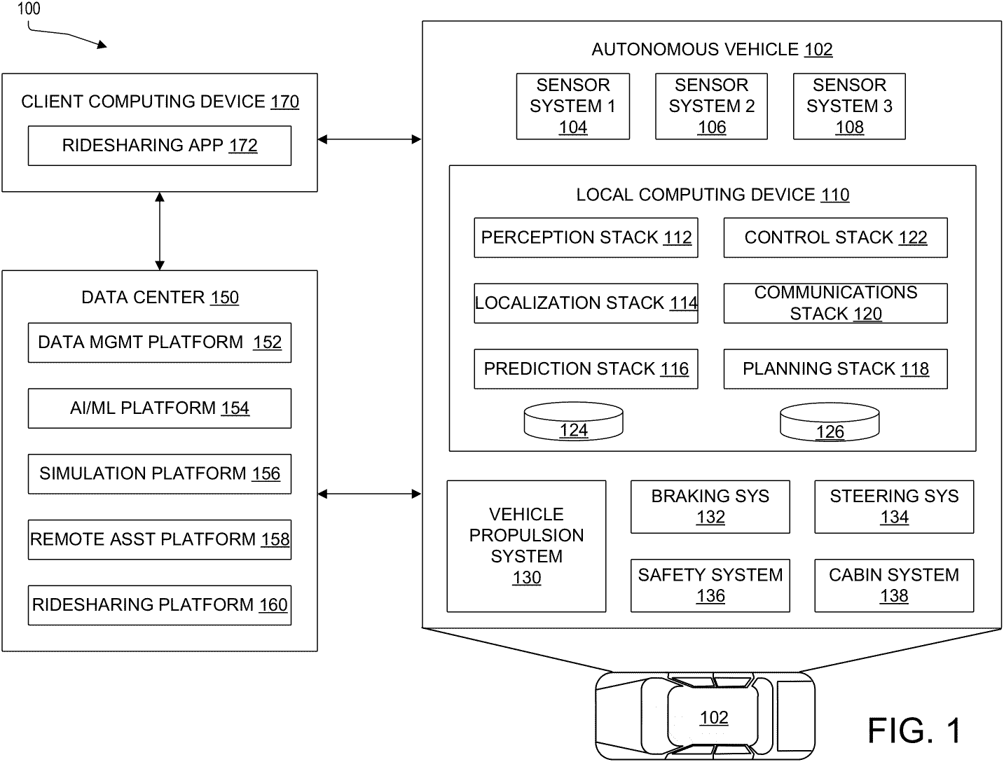

FIG. 1 illustrates an example of an AV management system 100. One of ordinary skills in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV’s environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV’s position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV’s steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112 - 122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other systems of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general-purpose computing devices for accessing the ridesharing application 172. The client computing device 170 can be a customer’s mobile computing device or a computing device integrated with the AV 102 (e.g., the local computing device 110). The ridesharing platform 160 can receive requests to pick up or drop off from the ridesharing application 172 and dispatch the AV 102 for the trip.

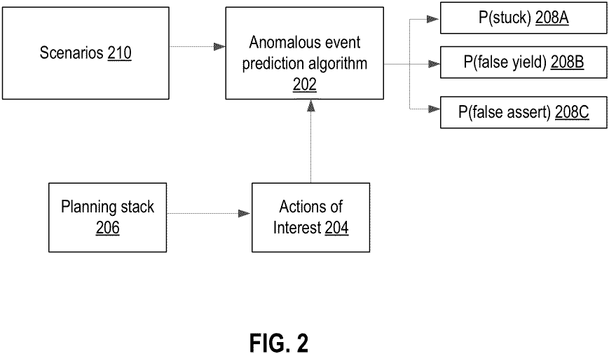

The action-conditioned model may also be referred to as anomalous event prediction algorithm. FIG. 2 is a diagram illustrating an anomalous event prediction algorithm for determining the probability of an anomalous event in accordance with some aspects of the present technology. An anomalous event prediction algorithm 202 includes an anomalous event prediction algorithm, which operates on an autonomous vehicle (AV) to provide the probability of the anomalous event. As illustrated in FIG. 2, the anomalous event prediction algorithm 202 receives input of action of interest 204. In some embodiments, the action of interest 204 can be a collection of possible or likely actions where each is evaluated. In some embodiments, the action of interest 204 can be output from a planning stack 206 of the AV as the AV considers committing to the action of interest provided by the planning stack 206.

The planning stack 206 is utilized by the AV to output a planned trajectory for the AV. The action of interest 204 is to assert and drive a route or yield to an object or a traffic signal. A scenario may have a tree of trajectories (actions) from which Non-Convex Solver (NCS) solves for a trajectory given different constraints and eventually picks one as its final output. The entire tree of trajectories may be taken as different possible actions, and the anomalous event prediction algorithm can span the entire action space by providing predictions that any of the actions in the entire action space might result in an anomalous event. The action of interest may be referred to as action encoding. A full trajectory can be reflected as in the embedding.

In some embodiments, it is possible to run this action-conditioned model in parallel with the rest of the planning stack of the AV to take all the last timestamped input and provide output as soon as possible.

The anomalous event prediction algorithm 202 includes a reinforcement learning schema: p(e|s,a) = r(s,a) + y V(s′), or in a more expressive form, p(e|s,a) = r(s,a) + y min_{a′}p(e\s′,a′), where y is a discount factor that helps learn the following evaluation.

Event signals can be captured early before the AV gets into undesirable situations. One nuance is that an approximation of optimal action is needed to approximate the prediction of the next step. The AV seed model can be used for this approximation since the AV seed model picks NCS solution 80% of the time.

However, since The anomalous event prediction algorithm 202 also receives input of scenarios 210 from various sources. For example, the scenario may be driving as perceived by a sensor of the AV. Scenario 210 may be defined by data including information about the location of the AV and objects surrounding the AV and their movement over a sequence of time leading up to a time of execution of the anomalous event prediction algorithm. The data defining scenario 210 may include (1) map road features, (2) a Lidar occupancy map showing objects represented in Lidar points represented overlaid the map of road features, (3) a perception summary providing semantic information and past path information for at least one of the objects represented in the Lidar points, and (4) a prediction summary providing a predicted path for the at least one object of the objects represented in the Lidar points.

In some variations, the perception summary includes bounding boxes around the objects represented in the Lidar points, semantic labels identifying a type of the respective objects in the bounding boxes, along with the past path information for the at least one of the objects.

In some variations, the predicted path for at least one of the objects includes at least one predicted location for the object at a future time along a predicted path of the at least one object, a probability that at least one of the objects will take the predicted path, and distribution of deviation from the predicted future location that represents a distribution of expected locations that at least one object might be located at the future time if the object were to take the predicted path.

The anomalous event prediction algorithm of anomalous event prediction algorithm 202 determines probabilities of a plurality of actions of interest and outputs probability for each of the anomalous events, including 208A-C. An anomalous event is an undesirable event. For example, anomalous event 208A may be a stuck event. The stuck event 208A is one in which the action results in a driving scenario in which the AV cannot autonomously navigate. The anomalous event 208B may also be a false yield event. The false yield event 208B is where the AV yields when the AV should not have. The anomalous event 208C may also be a false assert event. The false assert event 208C is when the AV drives a path that the AV should not have.

The anomalous event prediction algorithm is orthogonal to both Short-Term Action (STA) and Contextual Right of Way (CROW), which contribute to action planning. STA is a system predicting short-term action for every visible NPC. CROW is a system predicting if AV should assert/yield over an NPC. While STA or CROW can handle the particular scenario of all-way stop (AWS), the anomalous event prediction algorithm 202 is an independent system to provide online detection of anomalous events. The STA or CROW can help come up with action and uncertainty or confidence regarding this action, while the anomalous event prediction algorithm 202 evaluates the quality of this action. In other words, the CROW or STA can predict a value with some confidence, and the anomalous event prediction algorithm predicts the accuracy of such value.

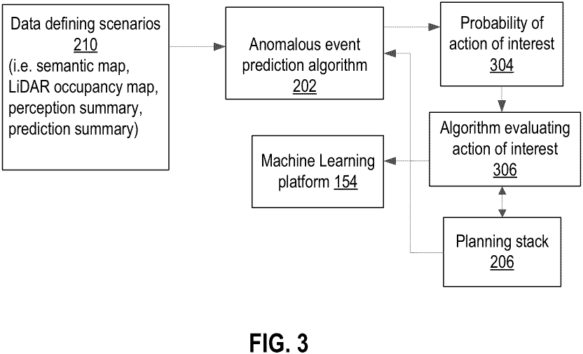

FIG. 3 is a diagram illustrating the anomalous event prediction algorithm of FIG. 2, and an algorithm evaluating actions of interest communicating with the planning stack of an autonomous vehicle (AV) in accordance with some aspects of the present technology. The anomalous event prediction algorithm 202 predicts a probability 304 of an anomalous event when receiving data defining scenarios 210 input from various sources, including a semantic map, LiDAR occupancy map, perception summary, and prediction summary, among others. The anomalous event prediction algorithm 202 also receives a list of actions of interest from the planning stack 206.

The probability 304 of the anomalous event is input into an algorithm 306 evaluating the action of interests, which can confirm a yield or assert a plan from the planning stack 206 of the AV. In some embodiments, the algorithm 306 evaluating the action of interest can be part of the planning stack 206.

In some embodiments, the algorithm 306 evaluating the action of interest may determine that the AV needs to ameliorate a consequence of an executed route. The consequence of the executed route may be that the AV is stuck, whereby the algorithm evaluating 306 the action of interest can quickly determine if the AV is stuck based on the received probability 304 of the anomalous event.

In some embodiments, the algorithm 306 evaluating the action of interest may determine that a planned output by the planning stack 206 is a bad plan. The algorithm 306 evaluating the action of interest may provide feedback to the planning stack 206 that increases the cost of the planned output by the planning stack 206. The planning stack 206 may reevaluate the planned output. The algorithm 306 evaluating the action of interest may provide a flag to identify the bad plan, where a heuristic that confirms the planned output by the planning stack will reject the plan.

The algorithm 306 evaluating the action of interest may provide a loss value to the machine learning model 154, which is trained to output actions of interest for execution by the AV. For example, outputs from the algorithm 306 evaluating the action of interest may be used to train a machine-learning algorithm that is part of the planning stack to output actions that have a low probability of resulting in an anomalous event.

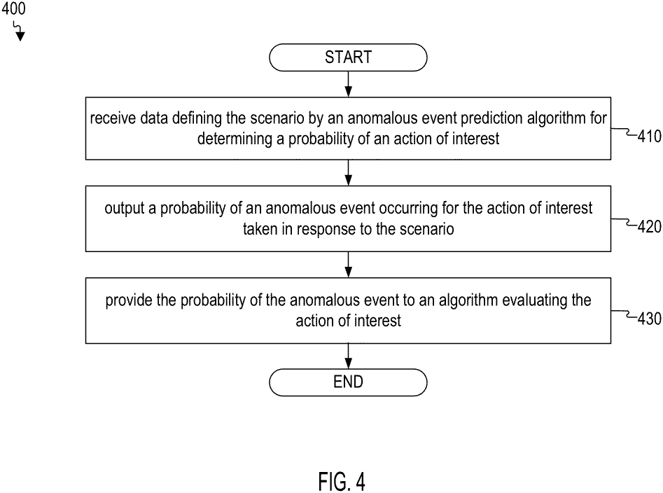

FIG. 4 illustrates an example method 400 for determining a probability of an anomalous event based on a scenario and an action of interest in accordance with some aspects of the present technology. Although example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

According to some examples, method 400 may include receiving data defining the scenario by an anomalous event prediction algorithm for determining a probability of action of interest at block 410. For example, the anomalous event prediction algorithm 202 as illustrated in FIG. 3 may receive data defining the scenario for determining a probability of action of interest.

In some variations, the anomalous event prediction algorithm operates on an autonomous vehicle (AV) to provide the probability of the anomalous event.

In some variations, the anomalous event prediction algorithm determines probabilities that any of a plurality of actions of interest will result in an anomalous event. For example, the action of interest can be an action output by a planning stack of the AV that the AV utilizes to output a planned trajectory for the AV. The action output by the planning stack might be to assert and drive a route or to yield to an object or a traffic signal.

In some variations, the scenario is driving as perceived by a sensor of the AV. The data defining the scenario can be information about the location of the AV and objects surrounding the AV and their movement over a sequence of times leading up to a time of execution of the anomalous event prediction algorithm. For example, the data defining the scenario can include map road features, a Lidar occupancy map showing objects represented in Lidar points represented overlaid the map of road features, a perception summary providing semantic information and past path information for at least one of the objects represented in the Lidar points, and a prediction summary providing a predicted path for the at least one object of the objects represented in the Lidar points.

According to some examples, method 400 may include outputting a probability of an anomalous event occurring for the action of interest taken in response to the scenario at block 420. For example, the anomalous event prediction algorithm 202 as illustrated in FIG. 3 may output a probability of an anomalous event occurring for the action of interest taken in response to the scenario.

According to some examples, method 400 may include providing the probability of the anomalous event to an algorithm evaluating the action of interest at block 430. For example, the anomalous event prediction algorithm 202 as illustrated in FIG. 3 may provide the probability of the anomalous event to an algorithm 306 evaluating the action of interest, whereby the algorithm 306 evaluating the action of interest uses the probability of the anomalous event to avoid the action of interest leading to the anomalous event or recognize the anomalous event more quickly to take steps to ameliorate a consequence of the anomalous event.

In some variations, an anomalous event is an undesirable event. For example, the undesirable event can be a false assert event, a false yield event, or a stuck event.

In some variations, algorithm 306 evaluating the action of interest relaxes a heuristic, where the heuristic is characterized by receiving outputs from a planning stack of the AV, whereby the heuristic can reach a quicker conclusion when the probability of the anomalous event is low for the action received from the planning stack. For example, the AV may generally utilize a heuristic to consider a path suggested by the planning stack of the AV. The heuristic can be used to validate a plan for the AV to assert itself and drive a path. However, this heuristic can be slow. Accordingly, the output of algorithm 306 affirming that the path suggested by the planning stack has a low probability of resulting in an anomalous event can simplify the heuristic and allow it to arrive at a conclusion more quickly. For example, the algorithm 306 evaluating the action of interest can confirm a yield or a plan to assert from the planning stack of the AV.

In some variations, algorithm 306 evaluating the action of interest determines that the AV needs to ameliorate a consequence of an executed route. For example, the consequence of the executed route may be that the AV got stuck, whereby the algorithm 306 evaluating the action of interest can quickly determine if the AV is stuck based on the received probability of the anomalous event.

In some variations, algorithm 306 evaluating the action of interest determines that a planned output by the planning stack is a bad plan. For example, when algorithm 306 evaluating the action of interest determines that a planned output by the planning stack, the algorithm 306 evaluating the action of interest provides feedback to the planning stack 206 that increases the cost of the planned output by the planning stack, whereby the planning stack will reevaluate the planned output.

In some variations, when the algorithm 306 evaluating the action of interest determines that a planned output by the planning stack is a bad plan, the algorithm 306 evaluating the action of interest provides a flag to identify the bad plan, whereby a heuristic that confirms the planned output by the planning stack will reject the plan.

In some variations, the algorithm 306 evaluating the action of interest provides a loss value to a machine learning model 154 being trained to output actions of interest for execution by the AV. For example, the output of the algorithm 306 can be used to train a machine-learning algorithm that is part of the planning stack to avoid recommending trajectories that will result in an anomalous event.

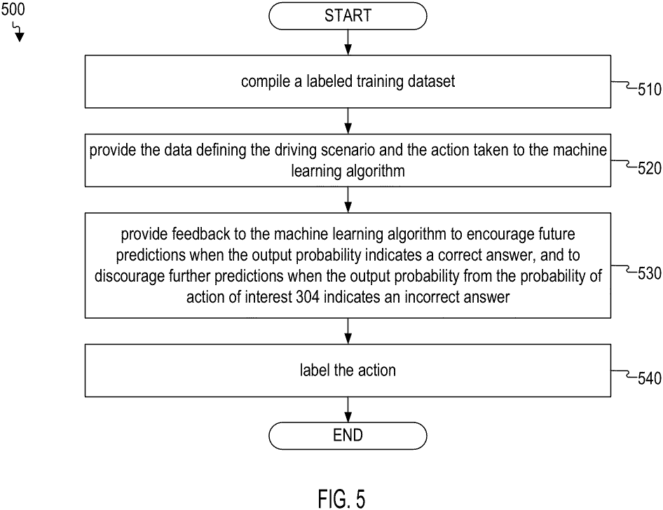

FIG. 5 is an example method 500 for training a machine learning algorithm for anomalous event prediction in accordance with some aspects of the present technology. Although the example method 500 depicts a particular sequence of operations, the sequence may be altered without departing from the scope of the present disclosure. For example, some of the operations depicted may be performed in parallel or in a different sequence that does not materially affect the function of method 500. In other examples, different components of an example device or system that implements the method 500 may perform functions at substantially the same time or in a specific sequence.

According to some examples, method 500 may include compiling a labeled training dataset at block 510. For example, the data management platform 152, as illustrated in FIG. 1, may be used to compile a labeled training dataset. The dataset includes data defining a driving scenario, an action taken in response to the scenario, and an anomalous event label.

The training data for the machine learning algorithm that will become the trained anomalous event prediction algorithm 202 may come from two sources, including 1) expert drivers supervising AV and 2) without expert drivers. When a driver performs a take over (TKO), the model can determine what action the AV plans and what action the driver performs. The model can label the action the AV plans as a bad outcome with a score of 1. The model can also label the action the driver performs as a good outcome, with a score of 0.

Without expert drivers, the model can get data from the planning stack that shows what actions the planning stack considers. The model can label the actions that have a high cost associated with the actions as bad outcomes and give the actions a score of 1. The model can label the action selected by the AV as a good outcome, with a score of 0. The dataset from the AV stack without a driver may be less influential on the model than the data from the expert driver.

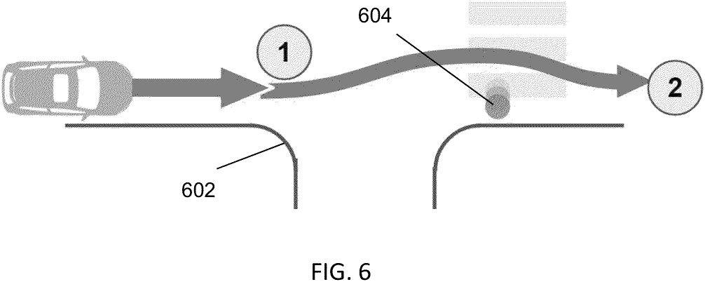

In some variations, the labeled training dataset is derived from data recorded by an autonomous vehicle (AV) while being supervised by a human co-pilot, where an action leading to an anomalous event is an action that a planning stack of the AV planned and the AV attempted to execute before the human co-pilot intervenes, method 500 may further include labeling the action leading to an anomalous event with the anomalous event label. An example of this is addressed with respect to FIG. 6.

In some variations, the anomalous event label also indicates non-anomalous events.

According to some examples, method 500 may include providing the data defining the driving scenario and the action taken to the machine learning algorithm at block 520. For example, the data management platform 152 illustrated in FIG. 1 may provide the data defining the driving scenario and the action taken to the machine learning algorithm that will become the trained anomalous event prediction algorithm 202. The machine learning algorithm is configured to receive the data defining the driving scenario and the action taken and output a probability that the action was taken in that driving scenario will lead to an anomalous event.

Data pipeline and training pipeline are critical to the model. Once both pipelines are in place, a new event signal can be added by mining-related events and fine-tuning the model. Method 500 may build a data mining pipeline by identifying retention issues and accumulating relevant data, including stuck, false assert or yield, comfort events. Method 500 may also build a training pipeline with an early iteration of feature representation and labels.

Method 500 may also include integrating with all intersection state-machines and remote assistance (RA) initiators by expanding prediction from to all output cycles of the AV stack, experimenting with feature representations, experimenting with labels, consolidating training pipeline, addressing latency issues, etc.

Method 500 may also add rarer events to explore various other use cases, and refine pre-trained backbone, among others.

According to some examples, method 500 may provide feedback to the machine learning algorithm to encourage future predictions when the output probability indicates a correct answer and to discourage further predictions when the output probability from the probability of action of interest 304 indicates an incorrect answer at block 530. For example, the probability of action of interest may provide feedback to the machine learning algorithm or anomalous event prediction algorithm to encourage future predictions when the output probability indicates a correct answer and discourage further predictions when the output probability indicates an incorrect answer.

According to some examples, method 500 may include labeling the action leading to an anomalous event with the anomalous event label at block 540. For example, the machine learning algorithm that will become the trained anomalous event prediction algorithm 202 may label the action leading to an anomalous event with the anomalous event label.

In some variations, an action taken by the human co-pilot intervenes is labeled as a non-anomalous event.

In some variations, the labeled training dataset is derived from data recorded by an autonomous vehicle (AV). An action that a planning stack of the AV plans and is executed safely can be given the anomalous event label of being a non-anomalous event.

In some variations, an action that the planning stack of the AV evaluates but associates with a cost that is too high to be chosen can be labeled with the anomalous event label leading to an anomalous event.

In some variations, the labeled training dataset is derived from data recorded by an autonomous vehicle (AV), wherein some of the data recorded by the AV is from instances wherein a human co-pilot intervened to take control of the AV, and some of the data recorded by the AV is from instances wherein the AV successfully pilots itself.

In some variations, the data derived from instances where the human co-pilot intervenes to take control of the AV can be given greater weight in the labeled training dataset, where the data derived from instances where the human co-pilot intervenes to take control of the AV can be more influential in the training of the machine learning algorithm.

### EXAMPLES

The following examples are for illustration purposes only. It will be apparent to those skilled in the art that many modifications, both to materials and methods, may be practiced without departing from the scope of the disclosure.

### Applications

The disclosed action-conditioned model can be used for various applications. For example, the disclosed action-conditioned model can be used for relaxing hand-crafted heuristics. The action-conditioned model can provide a quick evaluation of actions. Therefore, the output from the model can be used for selecting the most appropriate among action candidates. One example is the state-machine gating mechanism at intersections, where learned models and trajectory planning only come to plan after the state-machine selected an action heuristic. The disclosed action-conditioned model can be effective in this scenario.

The action-conditioned model can also be used as a safety net by providing an online assessment of the current scenario, given the intended AV action. Although there are various safety nets to keep the AV from getting into the worst scenarios. However, most of the current safety nets are not designed to maximize prompt response. As such, these current safety nets do not get triggered until the situation has already caused a severe delay or discomfort. The action-conditioned model can effectively handle the dynamic scenarios before the hand-crafted last resort gets triggered. An example of the action-conditioned model is the machine learning (ML) learned remote assistance (RA) initiator. It is a minimal scale prototype of the action-conditioned model but can still effectively capture on-road vehicle retrieval events (VRE) and call RA. The prototype eliminates more than 60% of the initialization failure VREs so far.

The action-conditioned model can also be used for supervising actions. The action-conditioned model introduces gradients corresponding to actions. Thus, the action-conditioned model can be easily applied as a cost. Also, the action-conditioned model can be used as an auxiliary loss to train other ML models, e.g., planning stack.

The action-conditioned model can further be used for measuring model reliability. A false prediction can be defined as a road event as long as both raw signal and stack output is input to the model. Therefore, the action-conditioned model can be used as an online detector for unreliable output and can also provide useful information, such as the correlation between false prediction and events.

### Event Labeling

FIG. 6 shows two potential actions of interest in accordance with some aspects of the present technology. As shown, AV 102 is approaching intersection 602. Action 1 is to yield to a pedestrian 604 near the intersection 602. Action 2 is to drive through the intersection 602.

The anomalous event prediction algorithm is action-conditioned and has benefits over a conventional direct scenario prediction. For example, in the first scenario, the AV takes action 2 to cross intersection 602, resulting in a false assert event where the AV drives too close to a pedestrian in a crosswalk. In a similar scenario, with some planning or prediction improvement, the AV takes action 1 not to cross intersection 602. The anomalous event prediction algorithm can pick up this difference while the conventional direct scenario prediction cannot determine the difference.

The action-conditioned model can directly leverage AV behavior with take-overs (TKOs) to automatically label events to be used in training the action-conditioned model. For example, the AV 102 is not yielding to pedestrians 604 and plans on executing action 2 to cross intersection 602, where an AV technician operator (AVTO) takes over and performs action 1. In this case with TKOs, the management platform 152 can label P(false assert | s, 1) = 0 + V and P(false assert | s, 2) = 1 (trajectory ends here) to be used in training the action-conditioned model.

In another case without TKOs, the AV 102 yields to pedestrian and executes action 1, where action 2 is an option in NCS with a high collision cost. In this case, the data management platform 152 can also label P(false assert | s, 1) = 0 + V and P(false assert | s, 2) = 1. However, since P(false assert | s, 2) = 1 is implied from NCS cost, it will be weighted less in the dataset compared to the labels with higher confidence.

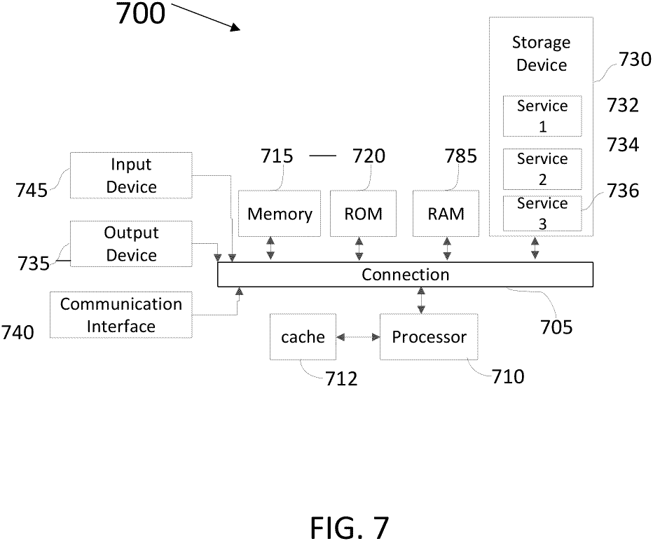

FIG. 7 shows an example of computing system 700, which can be, for example, used for all the calculations as discussed above, or can be any computing device making up the local computing system 110, remote computing system 150, (potential) passenger device executing rideshare app 170, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

The example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, close to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of many output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer-readable media which can store data that are accessible by a computer, such as magnetic cassettes, flash memory cards, solid-state memory devices, digital versatile disks, cartridges, random access memories (RAMs), read-only memory (ROM), and/or some combination of these devices.

The storage device 730 can include software services, servers, services, etc., and when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in the memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed:

1. A method for determining a probability of an anomalous event based on a scenario and an action of interest, the method comprising:
receiving data defining the scenario by an anomalous event prediction algorithm for determining a probability of an action of interest;
outputting a probability of an anomalous event occurring for the action of interest taken in response to the scenario; and
providing the probability of the anomalous event to an algorithm evaluating the action of interest, whereby the algorithm evaluating the action of interest uses the probability of the anomalous event to avoid the action of interest leading to the anomalous event or recognize the anomalous event more quickly to take steps to ameliorate a consequence of the anomalous event.

2. The method of claim 1, wherein the anomalous event prediction algorithm operates on an autonomous vehicle (AV) to provide the probability of the anomalous event, wherein the action of interest is an action output by a planning stack of the AV.

3. The method of claim 1, wherein the action of interest is to assert and drive a route, or to yield to an object or a traffic signal.

4. The method of claim 1, wherein the scenario is a driving scenario as perceived by a sensor of the AV, wherein the data defining the scenario is information about the location of the AV and objects surrounding the AV and their movement over a sequence of time leading up to a time of execution of the anomalous event prediction algorithm.

5. The method of claim 1, wherein the anomalous event is an undesirable event, wherein the undesirable event is one of a false assert event, a false yield event, or a stuck event.

6. The method of claim 1, wherein the algorithm evaluating the action of interest confirms a yield, asserts a plan from the planning stack of the AV, or determines that an AV needs to ameliorate a consequence of an executed route.

7. The method of claim 1, wherein the providing the probability of the anomalous event to an algorithm evaluating the action of interest results in the algorithm evaluating the action of interest to provide a loss value to a machine learning model being trained to output actions of interest for execution by the AV.

8. A system comprising:
a storage device configured to store instructions;
a processor configured to execute the instructions and cause the processor to:
receive data defining the scenario by an anomalous event prediction algorithm for
determining a probability of an action of interest,
output a probability of an anomalous event occurring for the action of interest taken in response to the scenario, and
provide the probability of the anomalous event to an algorithm evaluating the action of interest whereby the algorithm evaluating the action of interest uses the probability of the anomalous event to avoid the action of interest leading to the anomalous event or recognize the anomalous event more quickly to take steps to ameliorate a consequence of the anomalous event.

9. The system of claim 8, wherein the anomalous event prediction algorithm operates on an autonomous vehicle (AV) to provide the probability of the anomalous event.

10. The system of claim 8, wherein the action of interest is to assert and drive a route, or to yield to an object or a traffic signal.

11. The system of claim 8, wherein the scenario is a driving scenario as perceived by a sensor of the AV.

12. The system of claim 8, wherein the anomalous event is an undesirable event.

13. The system of claim 8, wherein the algorithm evaluating the action of interest confirms a yield, asserts a plan from the planning stack of the AV, or determines that an AV needs to ameliorate a consequence of an executed route.

14. The system of claim 8, wherein the algorithm evaluating the action of interest provides a loss value to a machine learning model being trained to output actions of interest for execution by the AV.

15. A non-transitory computer-readable medium comprising instructions, the instructions, when executed by a computing system, cause the computing system to:
receive data defining the scenario by an anomalous event prediction algorithm for determining a probability of an action of interest;
output a probability of an anomalous event occurring for the action of interest taken in response to the scenario; and
provide the probability of the anomalous event to an algorithm evaluating the action of interest, whereby the algorithm evaluating the action of interest uses the probability of the anomalous event to avoid the action of interest leading to the anomalous event or recognize the anomalous event more quickly to take steps to ameliorate a consequence of the anomalous event.

16. The computer-readable medium of claim 15, wherein the anomalous event prediction algorithm operates on an autonomous vehicle (AV) to provide the probability of the anomalous event.

17. The computer-readable medium of claim 15, wherein the action of interest is to assert and drive a route, or to yield to an object or a traffic signal.

18. The computer-readable medium of claim 15, wherein the scenario is a driving scenario as perceived by a sensor of the AV.

19. The computer-readable medium of claim 15, wherein the anomalous event is an undesirable event.

20. The computer-readable medium of claim 15, wherein the algorithm evaluating the action of interest confirms a yield, asserts a plan from the planning stack of the AV, or determines that an AV needs to ameliorate a consequence of an executed route.
